(19) United States
(12) Patent Application Publication
(10) Pub. No.: US 2023/0175850 A1
(43) Pub. Date: Jun. 8, 2023

(54) SYSTEMS AND METHODS TO ENFORCE A CURFEW

(71) Applicant: Ford Global Technologies, LLC, Dearborn, MI (US)

(72) Inventors: Mohammad Abouali, Canton, MI (US); Jeremy Lerner, Southfield, MI (US)

(73) Assignee: Ford Global Technologies, LLC, Dearborn, MI (US)

(21) Appl. No.: 17/543,586

(22) Filed: Dec. 6, 2021

(51) Int. Cl. G01C 21/34; B60R 25/01; G07C 5/02; H04W 12/64; H04W 12/02; H04W 4/021

(52) U.S. Cl. CPC G01C 21/3484; B60R 25/01; G07C 5/02; H04W 4/021; H04W 12/02; H04W 12/64

(57) ABSTRACT

The disclosure is generally directed to systems and methods to enforce a curfew upon a driver. In an example method, a processor makes a determination whether a vehicle operated by a driver is located inside a geofence during a curfew. The processor reports to user a violation of the curfew if the vehicle is not located inside the geofence during the curfew. The processor may also report an expected curfew violation (based on a speed and/or a distance evaluation of the vehicle) when the vehicle is unable to enter the geofence before a start of the curfew. If the vehicle is located inside the geofence during the curfew, the processor bestows privacy to a travel history of the driver. The travel history is associated with travel by the driver outside the geofence at times other than the curfew.

### BACKGROUND

Accidents involving drivers are often attributable to inexperience and youthful indiscretion. Some drivers tend to behave responsibly and generally abide by certain rules laid out by their parents or guardians. Others tend to be rebellious and may ignore rules. It is therefore desirable to provide solutions that allow parents or guardians to enforce such rules.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example vehicle that includes a curfew monitoring system in accordance with an embodiment of the disclosure.

FIG. 2 illustrates a first example scenario where an example geofence is used to identify a violation of a curfew in accordance with an embodiment of the disclosure.

FIG. 3 illustrates a second example scenario where some example geofences are used to identify violations of curfews in accordance with an embodiment of the disclosure.

FIG. 4 illustrates a third example scenario where some example geofences are used to identify violations of curfews in accordance with an embodiment of the disclosure.

### DETAILED DESCRIPTION

### Overview

In terms of a general overview, embodiments described in this disclosure are directed to systems and methods to enforce a curfew upon a driver. In an example method, a processor makes a determination whether a vehicle operated by a driver is located inside a geofence during a curfew. The processor reports to a user (e.g. an adult, such as a parent or guardian) a violation of the curfew if the vehicle is not located inside the geofence during the curfew. If the vehicle is located inside the geofence during the curfew, the processor bestows privacy to a travel history of the driver. The travel history is associated with travel by the driver outside the geofence at times other than the curfew.

In an example implementation, the processor may determine that the vehicle is traveling towards the geofence at a first instant in time prior to a start of the curfew. The processor may then determine a speed of travel of the vehicle and a distance between the vehicle and a perimeter of the geofence. Based on the speed of travel and the distance, the processor may determine that the vehicle will be unable to enter the geofence before the start of the curfew. If so, the processor reports to an adult that the driver is expected to be located outside the geofence for at least a portion of the curfew. A curfew may include, among other things, a time that a driver is not to be driving or should be drive within a specific geofence. A curfew may be any temporal or geographic limitations on an individual.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the phrase “driver” as used herein refers to a youth or other individual who is legally eligible to operate a vehicle and is under the care of an adult or guardian (such as, for example, a teenager under the care of a parent or guardian). The age of the youth can vary based on legal requirements in various jurisdictions (states, countries, etc.). The word “vehicle” as used herein refers to any of various types of vehicles such as, for example, a gasoline powered vehicle, an electric vehicle, a hybrid electric vehicle, an autonomous vehicle, a sedan, a van, a sports utility vehicle (SUV), a three-wheeler, and a two-wheeler (a motorcycle, for example). In scenarios where the vehicle is an autonomous vehicle, the “driver” may be controlling certain operations of the autonomous vehicle (such as, for example, setting a destination, setting a speed, securing the autonomous vehicle, etc.). In scenarios where the vehicle is a two-wheeler, the “driver” is a rider of the two-wheeler and the description provided below with respect to the example four-wheeled vehicle is equally pertinent to the two-wheeler.

It must also be understood that words such as “implementation,” “scenario,” “case,” “configuration,” “instance,” and “situation” as used herein are an abbreviated version of the phrase “In an example” (“implementation,” “scenario,” “case,” “configuration,” “approach,” “instance,” and “situation”) in accordance with the disclosure.” Furthermore, the word “example” as used herein is intended to be non-exclusionary and non-limiting in nature.

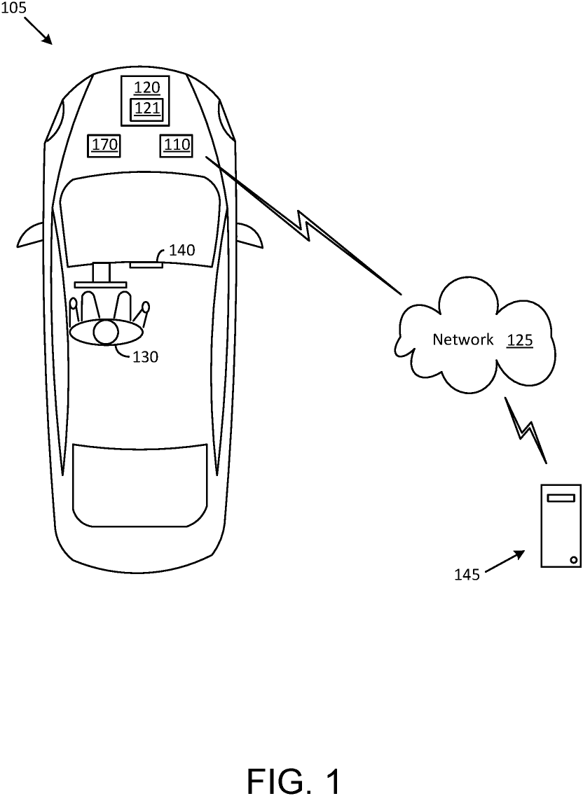

FIG. 1 illustrates an example vehicle 105 that includes a curfew monitoring system 120 in accordance with an embodiment of the disclosure. The vehicle 105 can include various other components such as, for example, a vehicle computer 170, an infotainment system 140, and a communication system 110.

The vehicle computer 170 may perform various functions such as controlling engine operations (fuel injection, speed control, emissions control, braking, etc.), managing climate controls (air conditioning, heating etc.), activating airbags, issuing warnings (check engine light, bulb failure, low tire pressure, vehicle in blind spot, etc.), and activating various vehicle components such as the horn and lights.

In an example implementation, the vehicle computer 170 is configured to provide various types of information to the curfew monitoring system 120. The vehicle computer 170 may provide the information either in an unprocessed format or in a processed format. The processed format may be produced by the vehicle computer 170 based on evaluating sensor data from one or more sensors and translating the sensor data to information, such as, for example, an acceleration characteristic of the vehicle 105, a braking characteristic of the vehicle 105, a cruise control characteristic of the vehicle 105. The vehicle computer 170 may also provide to the curfew monitoring system 120, information pertaining to traffic around the vehicle 105. In an example scenario, the information provided by the vehicle computer 170 may indicate to the curfew monitoring system 120 that the vehicle 105 is moving in stop-and-go traffic or is stopped.

The vehicle computer 170 may also provide to the curfew monitoring system 120, some other types of information pertaining to actions performed by a driver of the vehicle 105. For example, the vehicle computer 170 may monitor a fuel injection system and/or a braking system of the vehicle 105 to determine that the driver is executing an acceleration operation (or a braking operation) upon the vehicle 105 and convey this information to the curfew monitoring system 120.

The infotainment system 140 may include a combination of various entertainment devices (such as a radio, streaming audio solutions, and USB access ports for digital audio devices) with elements, such as a navigation system that provides navigation instructions and displays navigation maps upon a display screen of the infotainment system 140. The navigation system can include a global positioning system (GPS) device configured to provide to the curfew monitoring system 120, location information of the vehicle 105. In an example scenario, the navigation system is configured to detect a location of the vehicle 105 with respect to a geofence (not shown).

The communication system 110 supports communications between the curfew monitoring system 120 and various devices that may be located in the vehicle 105 and/or outside the vehicle 105. For example, the communication system 110 may support communications between the curfew monitoring system 120 and devices such as the vehicle computer 170 and the infotainment system 140 that are located in the vehicle 105. In an example implementation, a vehicle bus may be provided for this purpose. The vehicle bus may use a controller area network (CAN) bus protocol, a Media Oriented Systems Transport (MOST) bus protocol, and/or a CAN flexible data (CAN-FD) bus protocol. Some or all portions of the vehicle bus may also be implemented using wireless technologies such as Bluetooth®, Bluetooth®, Ultra-Wideband, Wi-Fi, Zigbee®, or near-field-communications (NFC).

The communication system 110 is further configured to support communications between the curfew monitoring system 120 and the server computer 145 via a network 125. The network 125 may include any one, or a combination of networks, such as a local area network (LAN), a wide area network (WAN), a telephone network, a cellular network, a cable network, a wireless network, and/or private/public networks, such as the Internet. For example, the network 125 may support communication technologies, such as TCP/IP, Bluetooth, cellular, near-field communication (NFC), Wi-Fi, Wi-Fi direct, machine-to-machine communication, and/or man-to-machine communication.

The curfew monitoring system 120 includes a processor 121 that executes various operations in accordance with the disclosure. A software application may be downloaded into the curfew monitoring system 120 in order to execute various operations in accordance with the disclosure. In an example operation, the vehicle 105 is operated by a driver and the processor 121 determines whether the vehicle 105 is located inside a geofence (not shown) during a curfew that may be imposed upon the driver by an adult (a parent or guardian, for example). The processor 121 reports to the adult, a violation of the curfew, if the vehicle 105 is not located inside the geofence during the curfew. If the vehicle 105 is located inside the geofence during the curfew, the processor 121 bestows privacy to a travel history of the driver 130. The travel history can be associated with travel by the driver 130 outside the geofence at times other than the curfew.

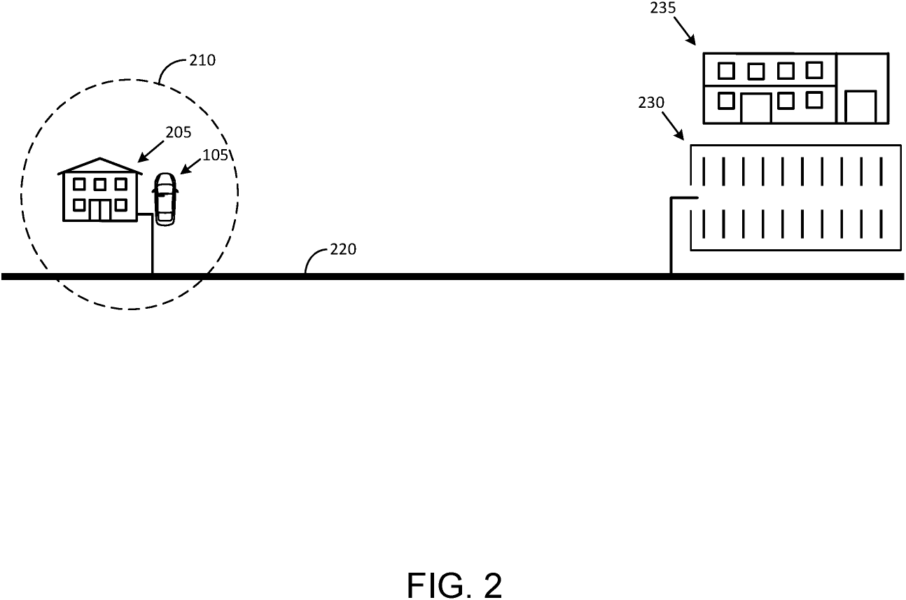

FIG. 2 illustrates an example environment that includes an example geofence 210 that may be used to enforce a curfew upon a driver in accordance with the disclosure. In this example, the geofence 210 is defined around a residence 205. The geofence 210 may be defined by various entities using various devices such as, for example, by a parent using a personal device (a smartphone, a tablet computer, a laptop computer, etc.).

In a first example implementation in accordance with the disclosure, the residence 205 is a house in which the driver resides along with one or more adults who are responsible for the driver such as, for example, a parent, a guardian, an older sibling, a relative (uncle, aunt, grandparent etc.). In another example implementation in accordance with the disclosure, the residence 205 is a living space in which the driver resides away from an adult who is responsible for the driver. An example living space can be a school dormitory, an on-campus residence (fraternity, sorority, etc.), or an off-campus residence that the driver shares with other youngsters.

A road 220 may be a part of a route that the driver typically traverses when commuting from the residence 205 to a parking lot 230 of his/her school 235. The driver may follow a typical routine that involves heading out from the residence 205 at around 7 AM, traveling on the road 220, parking his/her vehicle in the parking lot 230, attending classes in the school 235, and returning to the residence 205 at around 5 PM. In an example scenario, the driver remains inside the residence 205 until the next morning.

A software application that may be downloaded from the server computer 145 and into a device such as, for example, the personal device of the parent, the curfew monitoring system 120 in the vehicle 105, and/or a home computer in the residence 205, may be executed to enforce the curfew upon the driver. In an example scenario, an adult who is responsible for the driver may launch the software application in the personal device and enter information pertaining to the curfew. The information can include timing information related to the curfew.

With respect to the example described above, the adult who is responsible for the driver may define a curfew that extends from 5 PM of a weekday to 7 AM of the following weekday. The curfew may exclude weekends during which the driver is allowed to travel to other places such as, for example, a friend’s house, a movie theater, or a mall.

The software application provided in the curfew monitoring system 120 constantly monitors the location of the vehicle 105 (for example, by obtaining location information from the GPS device in the vehicle 105). In one case, the monitoring may be carried out on all days of the week (including weekends). In another case, the monitoring may be carried out only during the weekdays when the driver is expected to attend the school 235.

The curfew monitoring system 120 may report to the adult a violation of the curfew upon detecting a location of the vehicle 105 outside the geofence 210 during the curfew (for example, between 5 PM of a weekday and 7 AM of the following weekday). The report may be provided in various ways, such as, for example, in the form of a text message sent to the personal device of the adult. The adult may impose a punishment upon the driver for violating the curfew. An example punishment may involve curtailment of some or all activities outside of the geofence 210 over one or more weekends.

In another implementation, the punishment may be meted out automatically by the curfew monitoring system 120. Some example punishments that may be meted out automatically by the curfew monitoring system 120 can include disabling some or all functions of the infotainment system 140 (disabling music play, for example) and/or disabling some functions of a smartphone carried by the driver.

The curfew monitoring system 120 may also execute certain operations under certain circumstances. For example, in one case, the curfew monitoring system 120 may detect the vehicle 105 traveling in a wrong direction either during a curfew or just prior to the start of a curfew. The curfew monitoring system 120 then automatically configures the navigation system to provide instructions to the driver to travel towards the residence 205. If the driver persists in traveling in the wrong direction, the curfew monitoring system 120 may communicate with the vehicle computer 170 and advise the vehicle computer 170 to place a speed limit of travel upon the vehicle 105. The speed limit may be defined by the adult and the vehicle computer 170 may ensure that the speed limit does not violate speed rules applicable to the road on which the vehicle 105 is moving. In an example scenario, the adult may set a speed limit of 30 mph that is legal for travel on the road 220.

In some implementations, the curfew monitoring system 120 may also warn the driver of a violation prior to informing the adult of the violation or after informing the adult of the violation. The warning may be provided in various ways, such as, for example, in the form of a message displayed upon the infotainment system 140 of the vehicle 105 or an audio signal emitted by the infotainment system 140. The message may urge the driver to drive the vehicle 105 back into the geofence 210.

In some cases, the driver may be obedient and abide by the rules of the curfew by staying inside the geofence 210 during the curfew. In these cases, the curfew monitoring system 120 bestows upon the driver, privacy to the travel history of the driver. The travel history may be associated with travel by the driver outside the geofence 210 at times other than the curfew (such as, for example, over weekends).

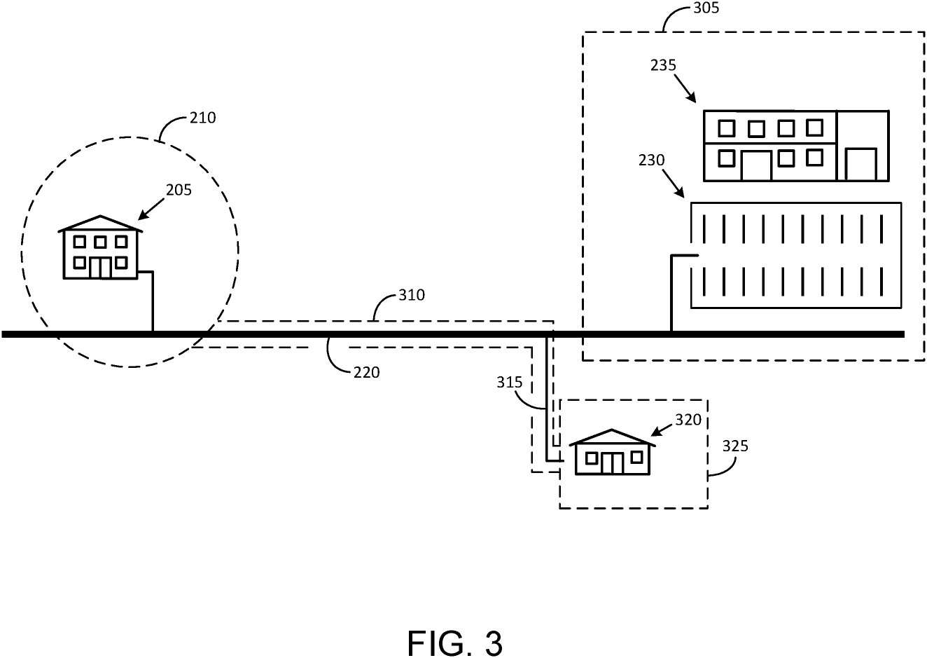

FIG. 3 illustrates a second example environment that includes a set of geofences used to enforce various curfews upon a driver in accordance with the disclosure. The set of geofences include the geofence 210 described above, a geofence 305 defined around the premises of the school 235, a geofence 325 defined around a house 320 in which a friend of the driver resides, and a geofence 310 that encloses the road 220 and a road 315 leading up to the house 320.

The set of geofences are generally directed at ensuring that the driver obeys various restrictions at various locations and at various times. The various restrictions may be defined by various entities using various devices such as, for example, by the parent using the personal device. In an example scenario, a first restriction may involve a first curfew extending from 8 PM of a weekday to 7 AM of the following weekday. The curfew monitoring system 120 may monitor the vehicle 105 and report to the adult a violation of the first curfew upon detecting a location of the vehicle 105 outside the geofence 210 during the first curfew.

A second restriction may involve a second curfew extending from 7 AM of a weekday to 8 AM of the same weekday during which the driver is expected to travel from the residence 205 to the school 235 via the road 220.

A third restriction may involve a third curfew extending from 8 AM of a weekday to 4 PM of the same weekday during which the driver is expected to attend classes in the school 235. The curfew monitoring system 120 may monitor the vehicle 105 and report to the adult a violation of the third curfew upon detecting a location of the vehicle 105 outside the geofence 305 during the third curfew.

A fourth restriction may involve a fourth curfew extending from 4 PM of a weekday to 5 PM of the same weekday during which the driver is expected to travel from the school 235 to the residence 205 via the road 220.

A fifth restriction may involve a fifth curfew extending from 5 PM of a weekday to 6 PM of the same weekday during which the driver is expected to travel from the residence 205 to the house 320 (via the road 220 and the road 315). The curfew monitoring system 120 may monitor the vehicle 105 and report to the adult a violation of the fifth curfew upon detecting a location of the vehicle 105 outside the geofence 310 during the fifth curfew.

A sixth restriction may involve a sixth curfew extending from 6 PM of a weekday to 7 PM of the same weekday during which the driver is expected to study along with the friend at the house 320 of the friend. The curfew monitoring system 120 may monitor the vehicle 105 and report to the adult a violation of the sixth curfew upon detecting a location of the vehicle 105 outside the geofence 325 during the sixth curfew.

A seventh restriction may involve a seventh curfew extending from 7 PM of a weekday to 8 PM of the same weekday during which the driver is expected to travel from the house 320 to the residence 205 via the road 315 and the road 220.

In some implementations, some of the curfews described above may be eliminated, or temporarily suspended, by an adult in order to grant the driver some freedoms as a result of good behavior.

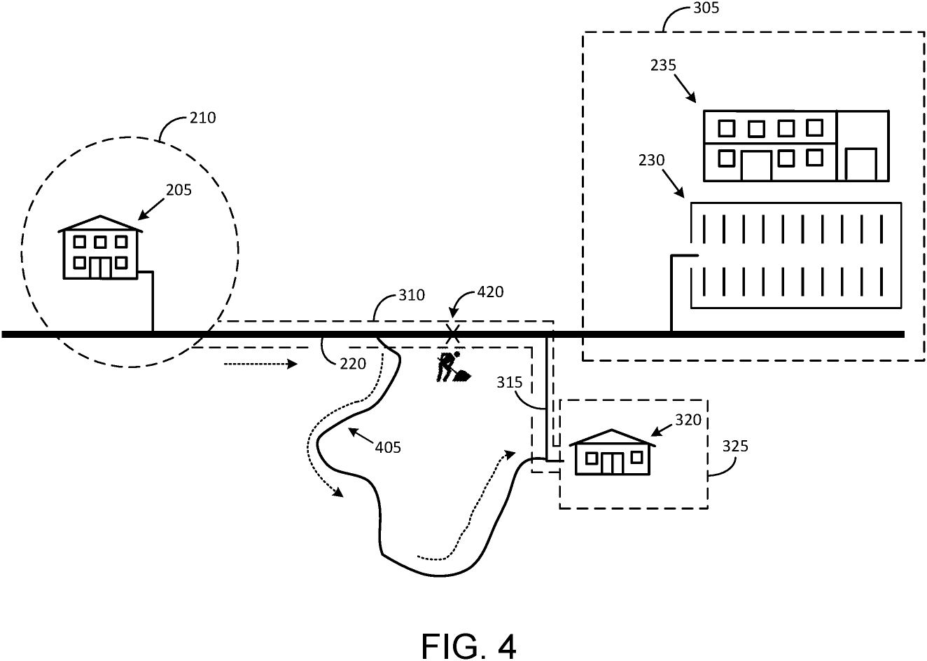

FIG. 4 illustrates an example scenario that may lead to an excusable curfew violation. In this example scenario, the driver sets out at 5 PM from the residence 205 to travel to the house 320 of his/her friend. The driver reaches a location 420 on the road 220 and discovers that further travel along the road 220 is not possible as a result of roadwork being carried out at the location 420. Consequently, the driver is compelled to turn around on the road 220 and seek an alternative route. An example alternative route involves travel along a long and circuitous road 405. The amount of time needed to travel on the road 405 prevents the driver from reaching the house 320 before expiry of the third curfew that extends from 5 PM to 6 PM on that day and may also prevent the driver from returning to his/her residence 205 before expiry of the curfew at 7 PM.

In this scenario, the curfew monitoring system 120 may detect a location of the vehicle 105 outside the geofence 325 and attempt to identify a contributing factor for the movement of the vehicle outside the geofence 310. If the contributing factor is not included in a list of acceptable reasons (e.g., road construction, late finish, etc.), the curfew monitoring system 120 reports the violation to the adult. On the other hand, if the contributing factor is included in the list of acceptable reasons, the curfew monitoring system 120 bestows privacy to a travel history of the driver.

Identifying the contributing factor can include obtaining information about traffic flow on the road 220 and detecting a traffic slowdown (or stoppage) ahead of the location 420. The curfew monitoring system 120 may then obtain information pertaining to the roadwork being carried out at location 420 from one or more sources such as, for example, the navigation system in the vehicle 105 (with live traffic monitoring), a news broadcast, or a wireless alert.

The curfew monitoring system 120 may report to the adult the violation of the geofence 310 accompanied by the reason for the violation (roadwork at the location 420). The adult may opt to excuse the curfew violation in this situation and the curfew monitoring system 120 will refrain from enforcing punitive actions.

In another example scenario, the curfew monitoring system 120 identifies a time, a location, and a speed of travel of the vehicle 105 upon the road 220 when the driver is returning from the house 320 to the residence 205. The curfew monitoring system 120 evaluates the time, location, and speed information and determines that the vehicle 105 will be unable to enter the geofence 210 prior to start of the curfew that is enforced via the geofence 210 (8 PM). Evaluating the location information can include determining a distance between the vehicle 105 and a perimeter of the geofence 210.

The curfew monitoring system 120 transmits a report to the adult, the report indicating that the driver is expected to be located outside the geofence 210 for at least a portion of the curfew. The adult may respond to the report by taking various action such as, for example, placing a phone call, sending a text, email, application message, etc. to the young driver to inquire about the cause for the delay in getting back to the residence 205, imposing a punishment upon the driver, and/or providing instructions to the curfew monitoring system 120 to execute one or more actions. Some example actions executed by the curfew monitoring system 120 in response to the instructions can include instructing the driver to drive carefully (rather than speeding up to meet the curfew), and may also include re-directing the vehicle 105 over a different route for various reasons such as personal safety.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey the information that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
determining, by a processor, a location of a vehicle relative to a geofence during a curfew;
reporting, by the processor, a violation of the curfew based on the vehicle not being located inside the geofence during the curfew; and
preventing access, by the processor, to a travel history of the vehicle based on the vehicle being located inside the geofence during the curfew.

2. The method of claim 1, wherein the geofence and the curfew are defined by a user.

3. The method of claim 1, wherein the travel history is associated with travel by the vehicle outside the geofence at times other than the curfew.

4. The method of claim 1, further comprising imposing limitations on the vehicle in response to the violation of the curfew.

5. The method of claim 1, further comprising:
determining, by the processor, that the vehicle is traveling towards the geofence at a first instant in time prior to a start of the curfew;
determining, by the processor, a speed of travel of the vehicle;
determining, by the processor, a distance between the vehicle and a perimeter of the geofence;
determining, by the processor, based on the speed of travel and the distance, that the vehicle will be unable to enter the geofence before the start of the curfew; and
reporting, by the processor, that the vehicle is expected to be located outside the geofence for at least a portion of the curfew.

6. The method of claim 1, further comprising:
determining, by the processor, that the vehicle is traveling towards the geofence at a first instant in time prior to a start of the curfew;
determining, by the processor, a speed of travel of the vehicle;
determining, by the processor, a distance between the vehicle and a perimeter of the geofence;
determining, by the processor, based on the speed of travel and the distance that the vehicle will be unable to enter the geofence before the start of the curfew; and
reporting, by the processor, an expected violation of the curfew.

7. The method of claim 6, further comprising:
identifying, by the processor, a contributing factor for the vehicle being unable to enter the geofence before the start of the curfew;
determining, by the processor, whether the contributing factor is included in a list of acceptable reasons; and
preventing access, by the processor, to the travel history of the vehicle based on the contributing factor being included in the list of acceptable reasons.

8. A method comprising:
defining a first geofence encompassing a residence;
defining a curfew for a driver of a vehicle; and
configuring a curfew monitoring system to report to a user a violation of the curfew if the vehicle is not located inside the first geofence during the curfew.

9. The method of claim 8, further comprising:
detecting, by a processor of the curfew monitoring system, that the vehicle is located inside the first geofence during the curfew; and
bestowing, by the processor, privacy to a travel history of the driver based on the vehicle being located inside the first geofence during the curfew.

10. The method of claim 9, wherein the travel history is associated with travel by the driver outside the first geofence at times other than the curfew.

11. The method of claim 8, further comprising:
detecting, by a processor of the curfew monitoring system, that the vehicle is located outside the first geofence during the curfew;
reporting, by the processor, the violation of the curfew; and
imposing, upon the driver, a limitation to the vehicle in response to the violation of the curfew.

12. The method of claim 8, further comprising:
defining a second geofence encompassing a section of a road that extends beyond the first geofence; and
configuring the curfew monitoring system to execute a responsive action upon detecting a movement of the vehicle outside the second geofence.

13. The method of claim 12, wherein the responsive action comprises at least one of disabling an operation of an audio system in the vehicle, disabling an operation of a phone system in the vehicle, automatically configuring a navigation system in the vehicle to provide guidance for the vehicle to travel to the second geofence, automatically configuring the navigation system in the vehicle to provide guidance for the vehicle to travel to the residence inside the first geofence, automatically placing a phone call or generating a text, email, or application message to report the movement of the vehicle outside the second geofence, or automatically imposing a speed limit of travel upon the vehicle.

14. The method of claim 12, wherein the responsive action comprises:
identifying, by a processor of the curfew monitoring system, a contributing factor for the movement of the vehicle outside the second geofence;
determining, by the processor, whether the contributing factor is included in a list of acceptable reasons; and
bestowing privacy, by the processor, to a travel history of the driver, if the contributing factor is included in the list of acceptable reasons.

15. A system comprising:
a curfew monitoring system comprising:
a memory that stores computer-executable instructions; and
a processor configured to access the memory and execute the computer-executable instructions to at least:
determining whether a vehicle operated by a driver is located inside a geofence during a curfew;
reporting a violation of the curfew if the vehicle is not located inside the geofence during the curfew; and
bestowing privacy to a travel history of the driver if the vehicle is located inside the geofence during the curfew.

16. The system of claim 15, wherein the curfew monitoring system is a part of one of a vehicle computer or a personal computer that is communicatively coupled to the vehicle computer.

17. The system of claim 15, wherein the geofence and the curfew are defined by a user and wherein the travel history is associated with travel by the driver outside the geofence at times other than the curfew.

18. The system of claim 15, wherein the processor is further configured to access the memory and execute additional computer-executable instructions to perform additional operations comprising:
determining that the vehicle is traveling towards the geofence at a first instant in time prior to a start of the curfew;
determining a speed of travel of the vehicle;
determining a distance between the vehicle and a perimeter of the geofence;
determining based on the speed of travel and the distance, that the vehicle will be unable to enter the geofence before the start of the curfew; and
reporting that the driver is expected to be located outside the geofence for at least a portion of the curfew.

19. The system of claim 15, wherein the processor is further configured to access the memory and execute additional computer-executable instructions to perform additional operations comprising:
determining that the vehicle is traveling towards the geofence at a first instant in time prior to a start of the curfew;
determining a speed of travel of the vehicle;
determining a distance between the vehicle and a perimeter of the geofence;
determining based on the speed of travel and the distance that the vehicle will be unable to enter the geofence before the start of the curfew; and
reporting an expected violation of the curfew.

20. The system of claim 15, wherein the processor is further configured to access the memory and execute additional computer-executable instructions to perform additional operations comprising:
identifying a contributing factor for the vehicle being unable to enter the geofence before a start of the curfew;
determining whether the contributing factor is included in a list of acceptable reasons; and
bestowing privacy to the travel history of the driver if the contributing factor is included in the list of acceptable reasons.
